(19) United States
(12) Patent Application Publication
(10) Pub. No.: US 2024/0079825 A1
(43) Pub. Date: Mar. 7, 2024

(54) PSAS RECEPTACLE CONNECTOR, PSAS PLUG CONNECTOR AND INTERCONNECTION SYSTEM THEREWITH

(71) Applicant: Amphenol Commercial Products (Chengdu) Co., Ltd., Chengdu (CN)

(72) Inventors: Kui Yang, Chengdu (CN); Xiaodong Hu, Chengdu (CN); Yaohua Hou, Chengdu (CN)

(73) Assignee: Amphenol Commercial Products (Chengdu) Co., Ltd., Chengdu (CN)

(21) Appl. No.: 18/240,401

(22) Filed: Aug. 31, 2023

(30) Foreign Application Priority Data
Sep. 1, 2022 (CN) 202211163442.9
Sep. 1, 2022 (CN) 202222524517.3

(51) Int. Cl. H01R 13/639; H01R 12/71; H01R 13/506

(52) U.S. Cl. CPC H01R 13/639; H01R 12/716; H01R 13/506

(57) ABSTRACT

Connectors for use with high-speed signals. Mating connectors may include interlocking components that control the mated position of the connectors such that wipe distance can be reduced. These components may be compact such that they can be integrated into connectors with standardized exterior dimensions. They may be integrated into mating guides of the mating connectors. For one of the mating connectors, such a component may be a locking member disposed in and curving out of its guide such that the locking member mates with a matching feature of a component in the guide of the other connector. As the connectors are secured by these components, the conductive elements may be shorter than the lengths required by standards, which reduces the stub and therefore increases signal integrity. Such a configuration provides higher signal integrity at higher speeds, while conforming to standards that constrain mating and mounting interfaces.

### RELATED APPLICATIONS

This application claims priority to and the benefit of Chinese Patent Application Serial No. 202222524517.3, filed on Sep. 1, 2022. This application also claims priority to and the benefit of Chinese Patent Application Serial No. 202211163442.9, filed on Sep. 1, 2022. The contents of these applications are incorporated herein by reference in their entirety.

### FIELD

This application relates to interconnection systems, such as those including electrical connectors, configured to interconnect electronic assemblies.

### BACKGROUND

Electrical connectors are used in many interconnection systems. It is generally easier and more cost effective to manufacture a system as several printed circuit boards (PCBs), which may be joined together with electrical connectors than to manufacture the system as a single assembly. A “PSAS” connector refers to a connector which supports both PCI-e (Peripheral Component Interconnect Express) and SAS (Serial Attached SCSI) interfaces.

SAS refers to a small scale computer system interface or Serial Attached SCSI, which is a computer hub technique applied for data transmission of peripheral components, such as an interface for equipment including a hard drive or CD-ROM. The SAS interface is derived from a parallel SCSI physical storage interface. Compared with the parallel manner, the serial manner of SAS interface provides a faster communication transmission rate and a simpler configuration. Also, SAS is compatible with serial ATA (SATA) equipment, wherein those interfaces apply a similar cable standard.

PCI-e refers to a high speed serial computer expansion bus standard. PCI-e is a high speed point-to-point double-channel with large transmission bandwidth. The equipment connected with PCI-e has the whole channel bandwidth instead of sharing the bus bandwidth. Such configuration is mainly applied for supporting active power management, error reporting, reliable end-to-end transmission, hot plugging, and quality of service (QOS) functions, achieving the advantage of a high speed data transmission. Presently, the 16×2.0 version reaches a transmission speed of 10 Gb/s, and such speed may still be improved further.

As data storage requirements increase, the transmission rate of connectors used with storage devices needs to be improved as well, especially for the server storage industry. The clock rate of higher data rate signals will increase, and the rise time of those data signals will be shorter. When used in enterprise-class servers and related high-speed transmission systems, the transmission rates of existing PSAS connectors may be 32 Gbps.

### BRIEF SUMMARY

Aspects of the present application relate to PSAS connectors and interconnection systems therewith.

Some embodiments relate to an electrical connector. The electrical connector may include a housing comprising a body having a mating face and a mounting face, a slot extending along the body, and a guide disposed at an end of the body and having a first slot; a plurality of conductive elements held by the housing, each of the plurality of conductive elements extending from the mounting face into the slot; and a locking member comprising a beam fixedly disposed in and curving out of the first slot of the guide.

Optionally, the beam may comprise a tail portion fixedly disposed in the first slot of the guide, a head portion opposite the tail portion and disposed in a second slot of the guide such that the head portion is movable inside the second slot of the guide, and a joint portion disposed between the head portion and the tail portion and protruding out of the guide.

Optionally, the beam may further comprise a guide portion joining the head portion and the joint portion, the guide portion inclined in a direction away from the head portion and out of the guide.

Optionally, the elastic beam may further comprise a support portion joining the tail portion and the joint portion and extending straight or bent toward the body of the housing.

Optionally, in a rest state, a side of the support portion that abuts the wall of the first slot and a side of the head portion abutting a blocking edge may be aligned in a same plane.

Optionally, the second slot and the first slot may be disposed sequentially along a direction away from the mating face and connected to each other.

Optionally, the electrical connector may comprise a board lock held by the housing, wherein the locking member and the board lock may be integrated or separate.

Optionally, the housing may further comprise a board mounting seat adjacent to the mounting face; and the board lock may be mounted to the board mounting seat.

Optionally, the locking member may be a metal member.

Some embodiments relate to an electrical connector. The electrical connector may include a housing comprising a tongue having a mating face, and a guide disposed at an end of the tongue and having a slot configured to receive a guide of a mating connector, the slot comprising a portion configured to receive a locking member of the mating connector; and a plurality of conductive elements held by the tongue, each of the plurality of the conductive elements comprising a portion disposed on a surface of the tongue, the portion disposed on the surface of the tongue having a length shorter than a standard length according to a PSAS standard.

Optionally, the portion of the receiving slot may comprise a first opening disposed on a sidewall of the guide and away from the tongue; and an edge of the first opening may be proximate to the mating face and configured to clamp a joint portion of the locking member of the mating connector.

Optionally, the sidewall of the guide may comprise a chamfer configured to engage the locking member of the mating connector.

Optionally, the electrical connector may comprise a strengthening member disposed in the portion of the receiving slot, the strengthening member comprising a second opening configured to clamp the locking member of the mating connector.

Optionally, the electrical connector may comprise a third opening disposed on the sidewall of the guide and exposing the second opening, wherein the second opening of the strengthening member may be disposed between the first opening and the third opening that may be disposed on the sidewall of the guide.

Optionally, the third opening may extend through an end of the guide.

Optionally, the electrical connector may further comprise a board lock held by the housing, wherein the strengthening member and the board lock may be integrated or separate.

Optionally, the board lock may have a body connected with the housing and extending from a mounting face toward the mating face.

Optionally, the strengthening member may be disposed on a same plane as the body of the board lock, or a portion of the strengthening member in which the second opening may be located may be offset relative to the body of the board lock body in a direction away from the tongue of the housing.

Some embodiments relate to an interconnection system. The interconnector system may include a first electrical connector and a second electrical connector mated with the first electrical connector. The first electrical connector may include a housing comprising a body, a slot extending along the body, and a guide disposed at an end of the body and having a first slot; a plurality of conductive elements held by the housing, each of the plurality of conductive elements extending into the slot; and a locking member disposed in and curving out of the first slot of the guide. The second electrical connector may include a housing comprising a tongue inserted in the slot of the first electrical connector, and a guide disposed at an end of the tongue and having a slot, wherein: the guide of the first connector may be inserted in the slot of the guide of the second electrical connector; the slot of the guide of the second electrical connector may comprise a portion that may have an opening disposed on a sidewall of the guide; and the locking member of the first electrical connector may be inserted in the portion of the slot and curves into the opening.

Optionally, the second electrical connector may comprise a plurality of conductive elements held by the tongue and mated with the plurality of conductive elements of the first electrical connector; and the conductive elements of the first connector and the conductive elements of the second connector may be configured such that, when the locking member may be engaged in the opening, a stub length of mated conductive elements may be less than 1.7 mm or shorter than a stub length specified in a PSAS standard.

Some embodiments relate to a PSAS receptacle connector. The PSAS receptacle connector may comprise a receptacle insulating housing, a receptacle conductive element and a locking member. The receptacle insulating housing may comprise an insulating body. The insulating body may have a receptacle mating face and a receptacle mounting face. The receptacle mating face may be provided with a slot extending along a longitudinal direction. The receptacle conductive element may be disposed on the insulating body and extend from the receptacle mounting face into the slot. The locking member may be provided on the receptacle insulating housing and disposed on the outer side of the insulating housing along the longitudinal direction. The locking member may be constructed, when the PSAS receptacle connector is connected to a mating PSAS plug connector, to be locked into a positioning slot on the PSAS plug connector.

Optionally, the receptacle insulating housing may further comprise a guide connected to a longitudinal end of the insulating housing. The guide may extend toward the receptacle mating face, and the locking member may be disposed on the guide.

Optionally, the PSAS receptacle connector may further comprise a receptacle board lock connected to the receptacle insulating housing. The receptacle board lock may be configured to fix the receptacle insulating housing to a circuit board. The locking member and the receptacle board lock may be integrated or separate.

Optionally, the locking member may comprise an elastic beam. The elastic beam may include a joint portion protruding beyond the receptacle insulating housing. The joint portion may be configured to be jointed with the positioning slot.

Optionally, the elastic beam may further comprise a tail portion and a head portion. The tail portion may be fixed. The joint portion may be disposed between the head portion and the tail portion. The head portion may be limited inside a second slot of the receptacle insulating housing and constructed to be movable inside the second slot under the action of the joint portion when the PSAS receptacle connector establishes a connection with or is disconnected from the mating PSAS plug connector.

Optionally, the elastic beam may further comprise a guide portion connected between the head portion and the joint portion. The guide portion may be inclined in a direction away from the head portion toward the outer side of the receptacle insulating housing. A surface of the joint portion back to the guide portion may be a joint surface for joining with the positioning slot.

Optionally, the elastic beam may further comprise a support portion connected between the tail portion and the joint portion.

Optionally, the support portion may be straight or bent toward the inside of the receptacle insulating housing.

Optionally, the support portion may abut against the receptacle insulating housing in a reverse direction opposite to the protruding direction of the joint portion.

Optionally, in a rest state, a side of the support portion and that of the head portion facing the reverse direction may be disposed on the same plane perpendicular to the longitudinal direction.

Optionally, a first slot recessed along the longitudinal direction toward the insulating housing may be provided on an end face of the receptacle insulating housing. The first slot may accommodate the support portion. The second slot may be recessed from the end face toward the insulating housing. The second slot and the first slot may be disposed sequentially along a direction away from the receptacle mating face and connected to each other. The slot edge of the first slot proximate to the receptacle mating face may be provided with a blocking edge extending toward the inside of the first slot. The head portion may be constrained by the blocking edge and retained within the second slot.

Optionally, the receptacle insulating housing may further comprise a board mounting seat connected to a longitudinal end of the insulating housing. The board mounting seat may be adjacent to the receptacle mounting face. In the case where the locking member and a receptacle board lock are of an integrated member, the receptacle board lock may be configured to be mounted to the board mounting seat along a direction from the receptacle mounting face toward the receptacle mating face and to be in interference fit with the board mounting seat. The head portion of the elastic beam may be configured to be inserted into the second slot during mounting the receptacle board lock.

Optionally, the joint portion may be bent along the longitudinal direction toward a direction away from the insulating housing.

Optionally, the locking member may be a metal member.

Some embodiments relate to a PSAS plug connector. The PSAS plug connector may comprise a plug insulating housing and a plug conductive element. The plug insulating housing may comprise an insulating tongue. The insulating tongue may have a plug mating face and a plug mounting face respectively disposed at each end thereof. The plug insulating housing may further be provided with a positioning slot. The positioning slot may be used, when the PSAS plug connector is connected to a mating PSAS receptacle connector, to be jointed with a locking member on the PSAS receptacle connector. The plug conductive element may be provided on the insulating tongue and extend from the plug mounting face to a side of the insulating tongue. The length of the plug conductive element may be shorter than a standard length. The plug conductive element may be configured to be used for electrical connection to the receptacle conductive element of the PSAS receptacle connector.

Optionally, the plug insulating housing may further comprise a slot disposed on the outer side of a longitudinal end of the insulating tongue. The slot may be used for receiving a guide of the PSAS receptacle connector. A portion of the slot may be formed as the positioning slot.

Optionally, a first opening may be disposed on a sidewall of the positioning slot away from the insulating tongue. An edge of the first opening proximate to the plug mating face may be configured to clamp a joint portion of the locking member.

Optionally, a strengthening member may be provided in the positioning slot. The strengthening member may be provided with a second opening. The second opening may be configured to clamp a joint portion of the locking member.

Optionally, a third opening may be disposed on a sidewall of the positioning slot away from the insulating tongue. The third opening may expose the second opening.

Optionally, the third opening may extend through to the plug mounting face.

Optionally, the PSAS plug connector may further comprise a plug board lock connected to the plug insulating housing. The plug board lock may be configured to fix the plug insulating housing to a circuit board. The strengthening member and the plug board lock may be integrated or separate.

Optionally, the plug board lock may have a plug board lock body connected with the plug insulating housing. The plug board lock body may be configured to be mounted to the plug insulating housing along a direction from the plug mounting face toward the plug mating face and to be in interference fit with the plug insulating housing.

Optionally, the strengthening member may be disposed on the same plane as the plug board lock body, or a portion of the strengthening member, in which the second opening is located, may be offset relative to the plug board lock body toward the outside of the plug insulating housing.

Some embodiments relate to an interconnection system is provided. The interconnection system may comprise anyone of the above-mentioned PSAS receptacle connector and anyone of the above-mentioned PSAS plug connector.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an interconnection system, according to some embodiments;

FIG. 2 is a cross-sectional perspective view of the interconnection system as shown in FIG. 1 taken by a plane perpendicular to a vertical direction;

FIG. 3 is a partial cross-sectional perspective view of the interconnection system as shown in FIG. 2;

FIG. 4 is a perspective view of an interconnection system, according to some embodiments;

FIG. 5 is a cross-sectional perspective view of the interconnection system as shown in FIG. 4 taken by a plane perpendicular to the vertical direction;

FIG. 6 is a partially cross-sectional view of the interconnection system as shown in FIG. 5;

FIG. 7 is a perspective view of the interconnection system as shown in FIG. 4 with a plug insulating housing hidden;

FIG. 8 is a perspective view of a PSAS receptacle connector, according to some embodiments;

FIG. 9 is a partial cross-sectional perspective view of the PSAS receptacle connector as shown in FIG. 8 taken by a plane perpendicular to the vertical direction;

FIG. 10 is a perspective view of a PSAS plug connector, according to some embodiments;

FIGS. 11A-11H are perspective views of locking members and receptacle board locks according to eight exemplary embodiments of the present disclosure; and

FIGS. 12A-12H are perspective views of strengthening members and plug board locks according to eight exemplary embodiments of the present disclosure.

The above accompanying drawings include the following reference signs:
100, PSAS connector; 200, PSAS receptacle connector; 300, receptacle insulating housing; 301, slot; 302, second slot; 302a, blocking edge; 303, first slot; 310, insulating body; 311, receptacle mating face; 312, receptacle mounting face; 320, guide; 322, end face; 330, board mounting seat; 332, mating groove; 410, receptacle conductive element; 420, locking member; 430, elastic beam; 431, joint portion; 431a, joint surface; 432, tail portion; 433, head portion; 434, guide portion; 435, support portion; 440, 440a, 440b, 440c, 440d, 440e, 440f, 440g, 440h, receptacle board lock; 4400, receptacle board lock body; 4402, barb; 500, PSAS plug connector; 600, plug insulating housing; 601, positioning slot; 6012, sidewall; 6014, notch; 602, first opening; 603, edge; 604, third opening; 610, insulating tongue; 611, plug mating face; 612, plug mounting face; 620, slot; 710, plug conductive element; 720, strengthening member; 721, second opening; 730, 730a, 730b, 730c, 730d, 730e, 730f, 730g, 730h, plug board lock; 7300, plug board lock body; 910, first circuit board; 920, second circuit board.

### DETAILED DESCRIPTION

The inventors have recognized and appreciated connector designs that satisfy electrical and mechanical requirements to support greater bandwidth and/or data transmission rates through high frequency operation. Some of these techniques may synergistically support higher frequency connector operation, satisfy the physical requirements set by industry standards such as PSAS, and meet requirements for mass manufacturing, including cost, time and reliability. Connectors satisfying the mechanical requirements of the PSAS specification are used as examples of connectors in which these techniques have been applied.

A PSAS connector may include a PSAS receptacle connector and a PSAS plug connector. The PSAS receptacle connector may be mounted on a first circuit board in a high-speed transmission system or connected to a first cable in the system, and receptacle conductive elements thereon may be interconnected with a circuit on the first circuit board or the first cable. The PSAS plug connector may be mounted on a second circuit board in the high-speed transmission system or connected to a second cable in the system, and plug conductive elements thereon may be interconnected with a circuit on the second circuit board or the second cable. When a connection is established between the PSAS receptacle connector and the PSAS plug connector, the receptacle conductive elements on the PSAS receptacle connector contact with the plug conductive elements on the PSAS plug connector to make an electrical connection. And then the electrical interconnection between the first circuit board or the first cable and the second circuit board or the second cable can be realized.

Before the PSAS plug connector is fully connected to the PSAS receptacle connector, a mating contact portions of the receptacle conductive element and the plug conductive elements may wipe each other. The distance between the location where the mating contact portions make first contact and the location where they are connected in their final mating may be referred to as a wipe distance. Such a wipe may remove contaminants, such as dust or oxides, from contact surfaces. Wipe may also ensure that conductive elements of the plug and receptacle connectors contact each other even when those connectors deviate from a designed final mating position of the connectors. Such deviations may occur, for example, if the plug and receptacle connectors move relative to each other in operation. Thus, the wipe distance is beneficial for improving electrical performances.

In the illustrated example, the plug conductive element has a flat mating contact portion and the receptacle conductive element has convex mating contact portion that wipes along the flat mating contact portion of the plug conductive element. Even though wipe has the benefits as described above, wipe leaves a stub on the plug conductive element. The stub may refer to a section of the plug conductive element from the location where the receptacle conductive element contacts the plug conductive element to a distal end of the mating contact portion of the plug conductive element. The stub has an impact on signal integrity (SI). The stub may be longest, which defines the worst case SI impact, when the connectors are fully mated and the length of the stub in this configuration may refer to the stub length.

As the transmission rates increase, the requirement for signal integrity of the PSAS connector also increases. The inventors have recognized and appreciated that an increasing impact of the stub on signal integrity. The stub is not desired. The inventors have further recognized and appreciated that better signal integrity can be achieved with shorter stub lengths (e.g., less than 1.7 mm or shorter than a stub length specified in a PSAS standard). However, in order to ensure the reliability of the contact between the mating contact portion of the receptacle conductive element and the mating contact portion of the plug conductive element, it is required to have a sufficient wipe distance. Thus, the wipe distance, or in other words, stub length, is somewhat contradictory in the two aspects as described above.

The inventors have recognized and appreciated that locking the PSAS receptacle connector to the PSAS plug connector with components that control the fully mated relative position of the mated connectors enables a reliable interconnection of the two and enables the wipe distance to be reduced. Consequently, the stubs may be shorter, which accordingly improves signal integrity. In the embodiments of the present disclosure, the PSAS receptacle connector may be provided with a locking member. When the PSAS receptacle connector is connected to a mating PSAS plug connector, the locking member may be locked inside a positioning slot on the PSAS plug connector. With this configuration, there is higher connection strength between the PSAS receptacle connector and the PSAS plug connector, thereby achieving a reliable interconnection.

Components that control the mated position of the mated connector may be compact such that the overall dimensions of the connectors need not be impacted. Such components, for example, may be integrated into connectors constructed according to the PSAS or other standard, without a deviation from the overall connector dimensions specified by the standard such that the mating and mounting interfaces of the connector are not impacted by inclusion of such components. The mating contact portions of the high speed signal conductors, however, may be made shorter than in the standard so as to provide reduced stub length (e.g., less than 1.7 mm or shorter than a stub length specified in a PSAS standard) and improved performance. Such components, for example, may be integrally formed with board locks of the mating connectors. Alternatively or additionally, the components may be integrated with guidance structures, such as guides, of the mating connectors. These components may be metal and may have portions, such as portions extending from the board lock, that interlock.

In combination with the drawings, the PSAS receptacle connector, the PSAS plug connector and the interconnection system in some embodiments are described in detail below.

A vertical direction Z-Z, a longitudinal direction X-X and a transverse direction Y-Y described herein may be perpendicular to each other. The vertical direction Z-Z may refer to a height direction of the PSAS connector. The longitudinal direction X-X may refer to a length direction of the PSAS connector. The transverse direction Y-Y may refer to a width direction of the PSAS connector.

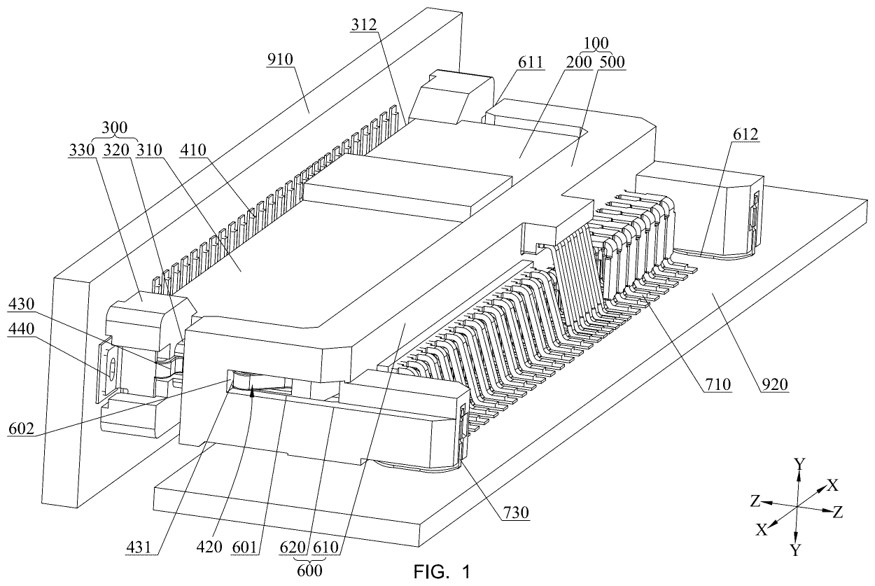

As shown in FIGS. 1-3, an electrical interconnect system may comprise a PSAS connector 100, a first circuit board 910 and a second circuit board 920. As illustrated, the PSAS connector 100 may comprise a PSAS receptacle connector 200 and a PSAS plug connector 500.

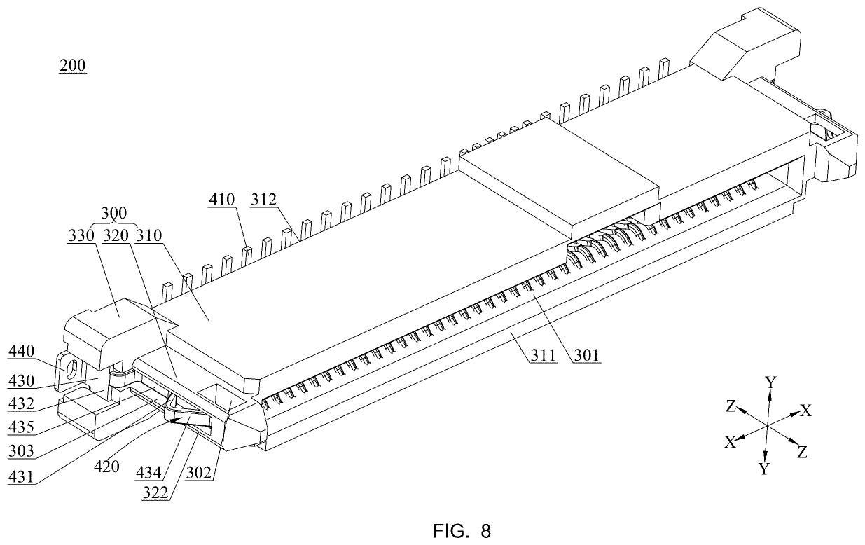

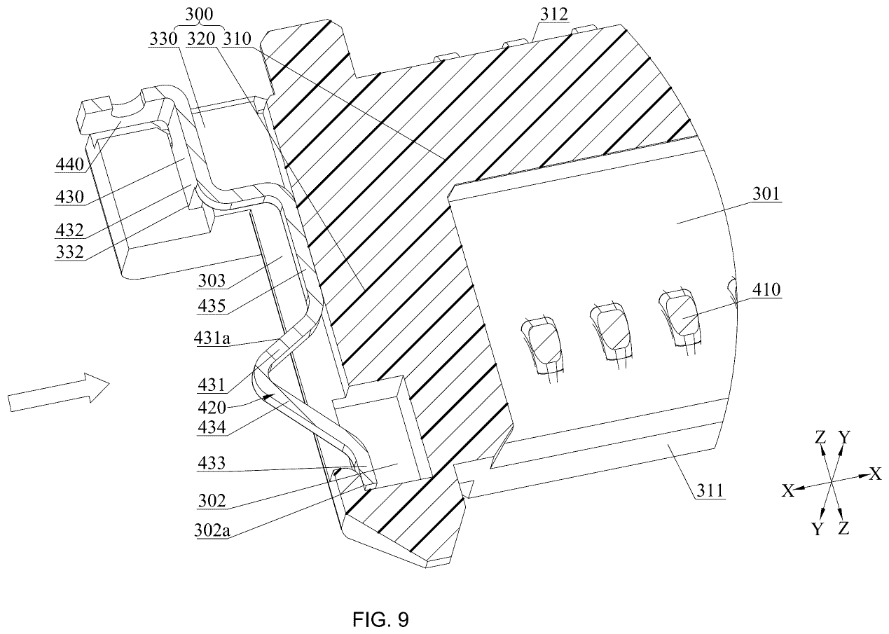

The PSAS receptacle connector 200 may comprise a receptacle insulating housing 300, a receptacle conductive element 410, and a locking member 420, as shown in FIGS. 8-9.

The receptacle insulating housing 300 may be molded from insulating materials, such as plastics. The plastics may include but be not limited to liquid crystal polymer (LCP), polyphenylene sulfide (PPS), high temperature nylon, polyphenylene oxide (PPO), polypropylene (PP), or other materials. In some embodiments, the plastics may be thermoset plastics. In some embodiments, the insulating plastics may be reinforced with fiberglass. The receptacle insulating housing 300 may generally be an integrated member. The receptacle insulating housing 300 may include an insulating body 310. The insulating body 310 may have a receptacle mating face 311 and a receptacle mounting face 312. In the embodiment as shown in the drawings, the receptacle mating face 311 and the receptacle mounting face 312 may be parallel to each other. The receptacle mating face 311 may be provided with a slot 301 extending along the longitudinal direction X-X. The slot 301 may be recessed toward the receptacle mounting face 312 so as to receive the head portion of the PSAS plug connector 500.

The receptacle conductive element 410 may be held by the insulating body 310. There may be a plurality of receptacle conductive elements 410. Adjacent receptacle conductive elements 410 may be disposed spaced apart to ensure that the adjacent receptacle conductive elements 410 are electrically insulated from each other. The receptacle conductive element 410 may be made of electrically conductive materials, such as metal. Each receptacle conductive element 410 is, in some embodiments, an elongated integrated member. The receptacle conductive element 410 may extend from the receptacle mounting face 312 into the slot 301. As illustrated, each receptacle conductive element 410 may include a receptacle mating contact portion and a receptacle mounting tail portion disposed on opposite ends along its extension direction. The receptacle mating contact portion may extend into the slot 301. The receptacle mounting tail portion may be connected to the first circuit board 910 by, for example, Surface Mounted Technology (SMT) and/or Through Hole Technology (THT). In this way, the PSAS receptacle connector 200 may be electrically connected to the first circuit board 910.

The receptacle conductive elements 410 may be arranged in two rows on both sides of the slot 301 along the transverse direction Y-Y, with each row extending along the longitudinal direction X-X. The receptacle mating contact portion of the receptacle conductive element 410 may protrude into the slot 301 so as to contact a plug mating contact portion of a plug conductive element 710 when the PSAS plug connector 500 is connected with the receptacle conductive element 410. In some embodiments, the receptacle mating contact portion is bent toward the inside of the slot 301 to protrude into the slot 301, and the protruding portion starts to wipe the plug mating contact portion from a front thereof when the PSAS plug connector 500 is connected with the receptacle conductive element 410, and stays at a final position after traveling a predetermined wipe distance, and which the PSAS plug connector 500 is connected with the receptacle conductive element 410 in place. Optionally, the two rows of receptacle conductive elements 410 may be aligned with each other along the longitudinal direction X-X. Optionally, the two rows of receptacle conductive elements 410 are staggered along the longitudinal direction X-X to increase the space between the receptacle conductive elements 410 to reduce crosstalk. The receptacle conductive element 410 may include a signal conductor, a reference conductor such as that connected to a ground terminal, and a power conductor. The reference conductor may be placed between high-speed signal conductors for separation.

The locking member 420 may be held by the receptacle insulating housing 300. Along the longitudinal direction X-X, the locking member 420 may be disposed on the outer side of the insulating body 310, as shown in FIGS. 8-9. The insulating body 310 may be substantially in the shape of a longitudinally elongated strip. The locking member 420 may be disposed on the outside of the insulating body 310. The locking member 420 is disposed on the outside of the slot 301, thus the insertion of the head portion of the PSAS plug connector 500 into the slot 301 may be carried out without interference. Exemplarily, the locking member 420 may be disposed at only one end of the insulating body 310. Optionally, the locking members 420 may be disposed at both ends of the insulating body 310 along the longitudinal direction X-X. One end of the locking member 420 may be connected to the receptacle insulating housing 300 by, for example, interference fit, connection pieces, etc., and the other end may extend along the insertion direction toward the PSAS plug connector 500.

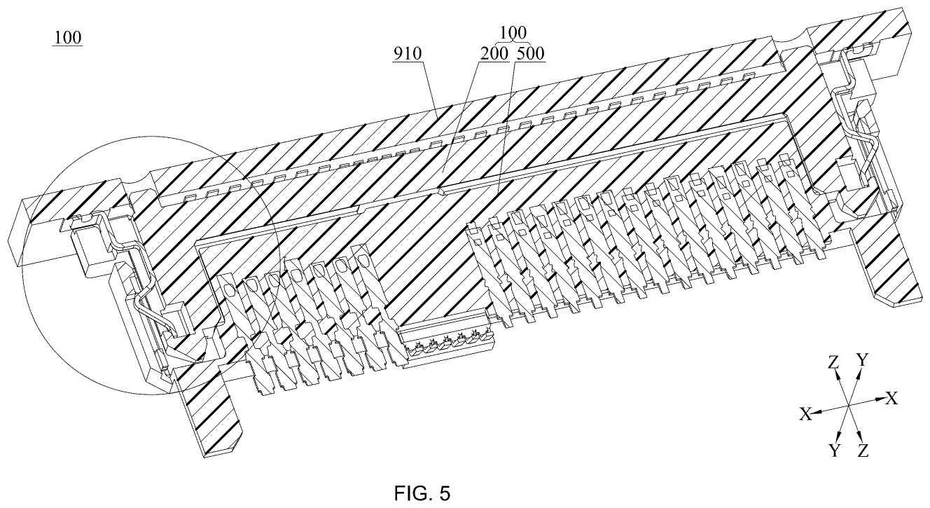

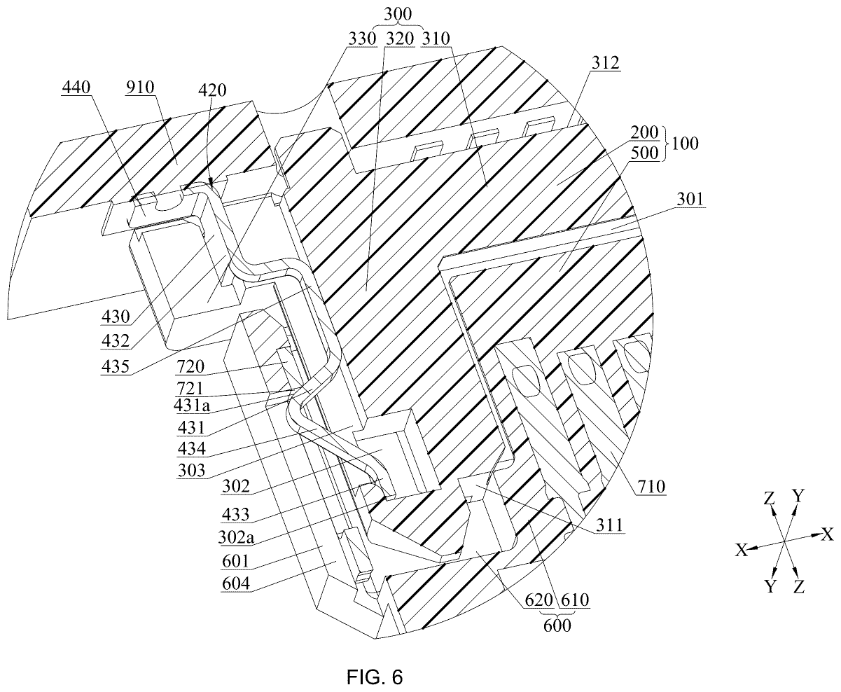

When the PSAS receptacle connector 200 is connected to the mating PSAS plug connector 500, the locking member 420 may be configured to be locked into a positioning slot 601 on the PSAS plug connector 500, as shown in FIGS. 1-6. Exemplarily, the locking member 420 may be locked into the positioning slot 601 in a variety of ways, including but not limited to the clamping pieces or connection pieces, etc. In order to increase the strength of the locking member 420 locking into the positioning slot 601, and thus increase the strength of the connection between the PSAS receptacle connector 200 and the PSAS plug connector 500, the locking member 420 may be made of materials with stronger strength, such as plastics, ceramics, metal, etc. Preferably, the locking member 420 is a metal member. The metallic materials are stronger and have lower material and processing costs. With this configuration, the locking member 420 has higher mechanical strength, is easier to process, and has lower material costs. The locking member 420 may be an integrated member, or a spliced member with multiple segments spliced together.

The PSAS plug connector 500 may comprise a plug insulating housing 600 and a plug conductive element 710.

The plug insulation body 600 may be molded from insulating materials, such as plastics. The plastics may include but be not limited to liquid crystal polymer (LCP), polyphenylene sulfide (PPS), high temperature nylon, polyphenylene oxide (PPO), polypropylene (PP), or other materials. In some embodiments, the plastics may be thermoset plastics. In some embodiments, the insulating plastics may be reinforced with fiberglass. The plug insulating housing 600 may generally be an integrated member. The plug insulating housing 600 may include an insulating tongue 610. The insulating tongue 610 may have a plug mating face 611 and a plug mounting face 612 disposed on each end thereof. In the embodiments as shown in the drawings, the plug mating face 611 and the plug mounting face 612 may be perpendicular to each other. The positioning slot 601 may be disposed on the plug insulating housing 600. The opening of the positioning slot 601 may be oriented to the insertion direction of the PSAS plug connector 500. The positioning slot 601 may be disposed on at least one of the two sides of the insulating tongue 610 that are opposite each other along the longitudinal direction. The positioning slot 601 may be disposed in one-to-one correspondence with the locking member 420. Optionally, the number of the positioning slot 601 may be greater than the number of the locking member 420. For example, the positioning slots 601 may be provided on both sides of the insulating tongue 610. The plug insulating housing 600 may mate with the receptacle insulating housing 300 having two locking members 420 and the receptacle insulating housing 300 having one locking member 420 and there is no need to separately mold different plug insulating bodies 600 for different numbers of locking members 420. The positioning slot 601 may be configured to be jointed with the locking member 420 on the PSAS receptacle connector 200 when the PSAS plug connector 500 is connected to the mating PSAS receptacle connector 200.

The plug conductive element 710 may be disposed on the insulating tongue 610. There may be a plurality of plug conductive elements 710. Adjacent plug conductive elements 710 may be disposed spaced apart to ensure that the adjacent plug conductive elements 710 are electrically insulated from each other. The plug conductive element 710 may be made of electrically conductive materials, such as metal. The plug conductive element 710 may be an elongated integrated member. The plug conductive element 710 may extend from the plug mounting face 612 to the side of the insulating tongue 610. As illustrated, the plug conductive element 710 may include a plug mating contact portion and a plug mounting tail portion disposed on each end along its extension direction. The plug mating contact portion may be disposed on the side of the insulating tongue 610. The plug mounting tail portion may be connected to the second circuit board 920 by, for example, Surface Mounted Technology (SMT) and/or Through Hole Technology (THT). In this way, the PSAS plug connector 500 may be electrically connected to the second circuit board 920.

The plug conductive elements 710 may be arranged in two rows on both sides of the insulating tongue 610 along the transverse direction Y-Y, with each row extending along the longitudinal direction X-X. Optionally, the two rows of plug conductive elements 710 may be aligned with each other along the longitudinal direction X-X. Optionally, the two rows of plug conductive elements 710 are staggered along the longitudinal directions X-X to increase the space between the plug conductive elements 710 to reduce crosstalk. The plug conductive element 710 may be configured to be electrically connected to the receptacle conductive element 410 of the PSAS receptacle connector 200. The plug conductive element 710 may be disposed in one-to-one correspondence with the receptacle conductive element 410.

When the first circuit board 910 and the second circuit board 920 are required to be electrically connected, the insulating tongue 610 may be inserted into the slot 301. In the process of insertion, the receptacle mating contact portion of the receptacle conductive element 410 may wipe the surface of the plug mating contact portion of the corresponding plug conductive element 710. When the two connectors are connected in place, the receptacle mating contact portion rests at a predetermined position of the plug mating contact portion, which forms a good contact with the plug mating contact portion, thereby realizing an electrical connection. And then, the first circuit board 910 and the second circuit board 920 can be electrically connected. The locking member 420 may be gradually inserted and eventually locked into the positioning slot 601 on the PSAS plug connector 500 in the process of the connection of the two connectors. In this way, by locking the locking member 420 to the positioning slot 601, the interconnection between the first circuit board 910 and the second circuit board 920 has higher strength, and thus the stability of the connection of the two can be improved. As a result, the wipe distance can be appropriately reduced so that the length of the stub can be shortened. In this way, a better integrity of the signals transmitted by the PSAS connector 100 can be ensured.

In the embodiments of the present disclosure, after the conductive elements of the PSAS plug connector 500 and the PSAS receptacle connector 200 are connected in place, the locking member 420 on the PSAS receptacle connector 200 can be inserted into the positioning slot 601 of the PSAS plug connector 500, thereby achieving the locking of the PSAS plug connector 500 to the PSAS receptacle connector 200, which can form a reliable connection with a reduced wipe distance. As a result, the length of the plug conductive element 710 can be shorter than a standard length. In some existing specifications, the length of the plug conductive element may be around 2 mm to 5 mm. In the embodiments of the present disclosure, the length of the plug conductive element can be appropriately shortened. With this configuration, the signal integrity of the interconnection system can be improved. And, the shortened length of the stub of the plug conductive element 710 leads to that the length of the plug mating contact portion of the plug conductive element 710 becomes shorter, which also reduce the costs of the PSAS connector 100. As a result, an appropriate shortening the length of the insulating tongue 610 can also be considered. And the stub of the PSAS plug connector 500 can be shortened, which is beneficial to improve the high frequency SI performance of the PSAS connector 100.

Exemplarily, as shown in FIGS. 1-3 and 8-9, the receptacle insulating housing 300 may further comprise a guide 320. The guide 320 may be connected to a longitudinal end of the insulating body 310. The guide 320 may be integrally formed with the insulating body 310. The guide 320 may extend toward the receptacle mating face 311. When the PSAS receptacle connector 200 and the PSAS plug connector 500 are connected, the guide 320 may be inserted into the positioning slot 601 of the plug insulating housing 600, thereby limiting the PSAS plug connector 500 in a plane parallel to the receptacle mating face 311.

The locking member 420 may be disposed on the guide 320. In this way, when the guide 320 is inserted into the plug insulating housing 600, the locking member 420 may follow the guide 320 into the positioning slot 601. The locking member 420 may be clamped inside the positioning slot 601 to achieve limiting and fixation in the insertion direction by the locking member 420. By disposing the locking member 420 on the guide 320, the existing positioning slot 601 may be configured to be mated with the locking member 420, which will not lead to a change in the shape of the PSAS plug connector 500 and the PSAS receptacle connector 200 after they are connected. This can avoid larger changes to the molds used to make the receptacle insulating housing 300 and the plug insulating housing 600, and may just require changes to cores in the molding process. As a result, the significant increase in the costs associated with improving the products can be greatly reduced.

Optionally, the locking member 420 may be inserted onto the guide 320. For example, the locking member 420 may be interference fit to the guide 320 for a tight fit with the guide 320. The manufacturing process of separate manufacturing followed by assembly has a lesser impact on the costs of the PSAS receptacle connector 200. Optionally, the locking member 420 may also be mounted onto the guide 320 not by insertion, but by secondary molding of the receptacle insulating housing 300 on the locking member 420, and in such a way the locking member 420 is fixed to the guide 320. However, this may result in higher processing costs for the receptacle insulating housing 300.

Exemplarily, as shown in FIGS. 1-3, the PSAS receptacle connector may further comprise a receptacle board lock 440. The receptacle board lock 440 may be connected to the receptacle insulating housing 300. The receptacle board lock 440 may be configured to fix the receptacle insulating housing 300 to the first circuit board 910. In the family of PSAS connectors, some of the PSAS connectors are used to interconnect two circuit boards, some of them are used to interconnect two bundles of cables, and the rest of them are used to interconnect a circuit board to a cable. Although the illustrated embodiment is for use in electronic systems in which two circuit boards are interconnected, techniques described herein may be used to interconnect cables to a board and/or cables.

The receptacle board lock 440 may be made of materials with stronger strength, such as, plastics, ceramic, metal, etc. Preferably, the receptacle board lock 440 is made of metallic materials. Metallic materials are stronger and have lower material and processing costs. The receptacle board lock 440 may be manufactured separately from the receptacle insulating housing 300. One end of the receptacle board lock 440 may be fixed to the receptacle insulating housing 300 by interference fit, and the other end may be fixed to the first circuit board 910 by any suitable methods, such as clamping pieces, welding, or connection pieces.

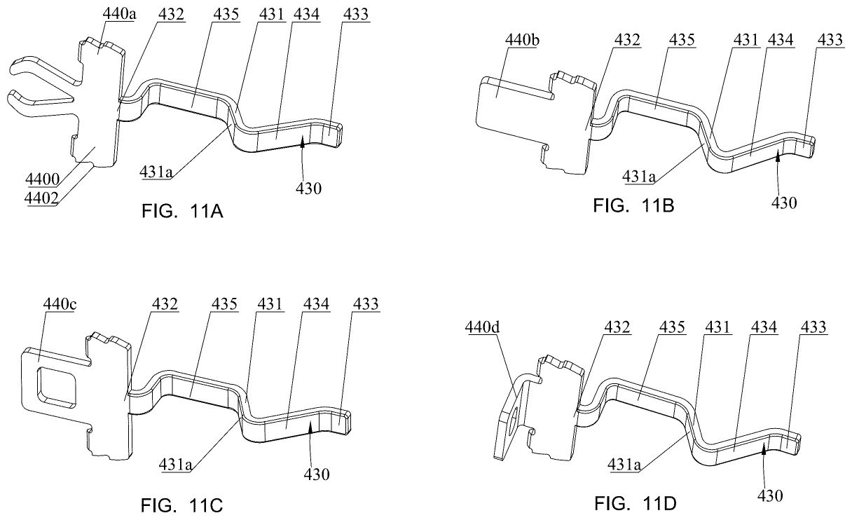

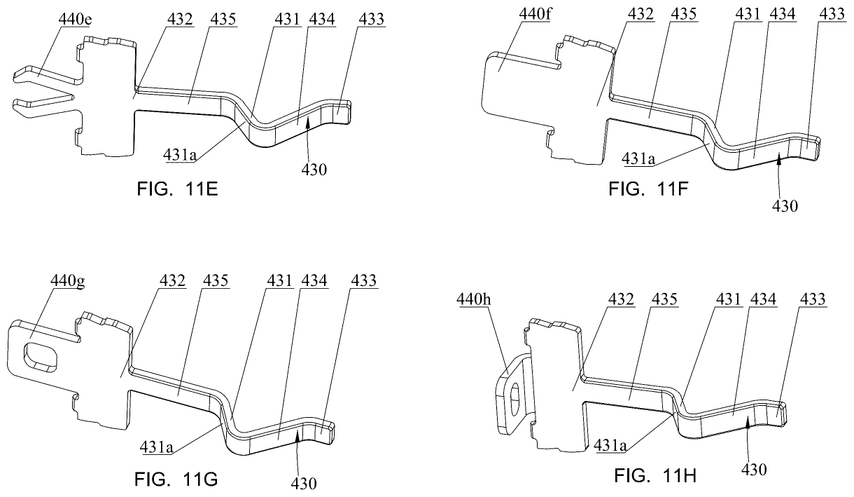

Referring to FIGS. 11A-11H, the receptacle board lock may have a variety of forms. As illustrated, a receptacle board lock 440a and a receptacle board lock 440e may respectively include a fork lock. The fork lock has ends spaced apart so that it can be elastic. The receptacle board lock 440a and the receptacle board lock 440e may be fixed to the first circuit board 910 by inserting and clamping the fork lock into the through-hole on the first circuit board 910. A receptacle board lock 440b and a receptacle board lock 440f may respectively include a tab. The receptacle board lock 440b and the receptacle board lock 440f may be fixed to the first circuit board 910 by inserting and clamping the tab into the through-hole on the first circuit board 910. A receptacle board lock 440c and a receptacle board lock 440g may respectively include a SMT soldering tail perpendicular to the first circuit board 910. The receptacle board lock 440c and the receptacle board lock 440g may be fixed to the first circuit board 910 by inserting the SMT soldering tail into the through-hole on the first circuit board 910 and soldering it onto the first circuit board 910. A receptacle board lock 440d and a receptacle board lock 440h may respectively include a SMT soldering tail parallel to the first circuit board 910. This SMT soldering tail differs from the perpendicular SMT soldering tail as shown in FIGS. 11C and 11G in different orientation. With respect to the receptacle board lock 440d and the receptacle board lock 440h, they may abut against the first circuit board 910, and the first circuit board 910 may not be provided with a corresponding through-hole.

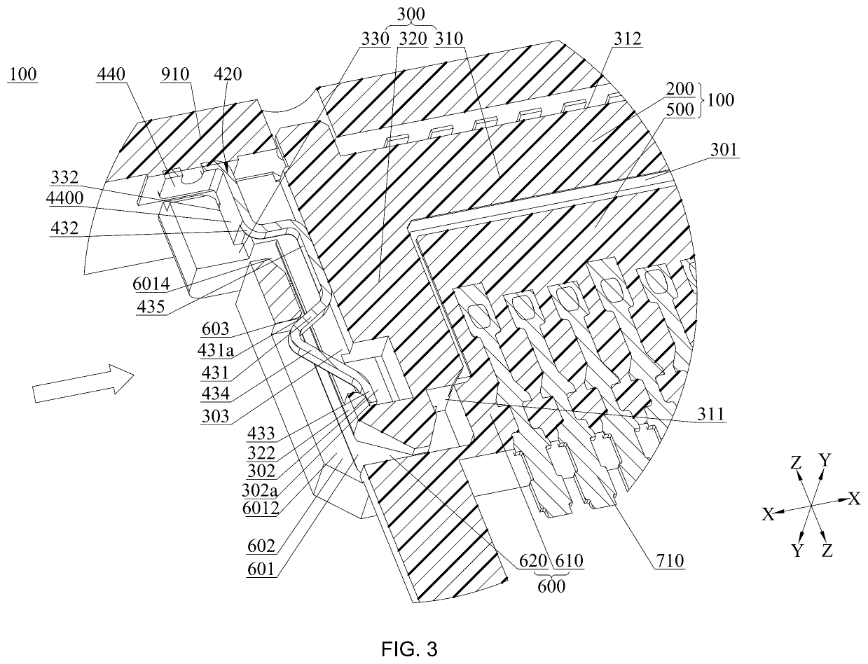

Regardless of the manners by which the receptacle board locks are locked to the first circuit board 910, the receptacle board locks 440a, 440b, 440c, 440d, 440e, 440f, 440g, 440h are substantially in slice shape. They may all be connected to the receptacle insulating housing 300 by interference fit. For example, the receptacle boards locks 440a, 440b, 440c, 440d, 440e, 440f, 440g, 440h may be provided with barbs on both sides of a receptacle board lock body thereof that are connected to the receptacle insulating housing 300. Referring to FIG. 11A, barbs 4402 are provided on both sides of a receptacle board lock body 4400 of the receptacle board lock 440a, respectively. The receptacle board lock body 4400 may remain inside a mating groove 332 on the receptacle insulating housing 300 by using the barbs 4402, as shown in FIG. 3.

Exemplarily, as shown in FIGS. 1-3 and 8-9, the receptacle insulating housing 300 may further comprise a board mounting seat 330. The board mounting seat 330 may be connected to the longitudinal end of the insulating body 310. The board mounting seat 330 may be adjacent to the receptacle mounting face 312. The guide 320 may be connected to the side of the board mounting seat 330 back to the receptacle mounting face 312. The mating groove 332 may be disposed on the side of the board mounting seat 330 facing the receptacle mounting face 312. In the case where the locking member 420 and the receptacle board lock 440 are of an integrated member, the receptacle board lock 440 may be configured to be mounted to the board mounting seat 330 along a direction from the receptacle mounting face 312 toward the receptacle mating face 311 and to be in interference fit with the board mounting seat 330. A head portion 433 of an elastic beam 430 may be configured to be inserted into a second slot 302 during mounting the receptacle board lock 440. In this way, after the PSAS receptacle connector 200 is connected to the first circuit board 910, the PSAS receptacle connector 200 together with the first circuit board 910 may limit the locking member 420 and the receptacle board lock 440.

Exemplarily, the locking member 420 and the receptacle board lock 440 may be separate, with each being a separate part. Exemplarily, the locking member 420 and the receptacle board lock 440 may be joined together by any suitable methods such as welding, bonding, molding and so on. Preferably, the locking member 420 and the receptacle board lock 440 may be of an integrated member formed by punching and so on. In some embodiments, the receptacle board lock 440 is made of metallic materials. Forming the locking member 420 integrally with the receptacle board lock 440 can reduce processing costs. Moreover, the locking member 420 may follow the receptacle board lock 440 in being made of metallic materials as well. The locking member 420 made of metallic materials may have both better mechanical strength and more sufficient elasticity. As a result, during the connection or separation of the PSAS receptacle connector 200 and the PSAS plug connector 500, the elastic deformation of the locking member 420 itself under the action of an external force makes both the plugging and unplugging of the PSAS plug connector 500 easier.

Exemplarily, as shown in FIG. 3, the locking member 420 may comprise the elastic beam 430. The elastic beam 430 may have a joint portion 431. The joint portion 431 may protrude beyond the receptacle insulating housing 300. Exemplarily, the joint portion 431 may be bent along the longitudinal direction X-X toward a direction away from the insulating body 310. In other embodiments, the joint portion 431 may be bent along the transverse direction Y-Y toward either of the two sides of the insulating body 310. In the case where the locking member 420 is disposed on the guide 320, the joint portion 431 may protrude to an end face 322 of the guide 320. The side of the guide 320 opposite the end face 322 is connected to the insulating body 310. The joint portion 431 may be configured to be jointed into the positioning slot 601.

Exemplarily, a first opening 602 may be provided on a sidewall 6012 of the positioning slot 601 away from the insulating tongue 610, as shown in FIG. 3. After the PSAS plug connector 500 and the PSAS receptacle connector 200 are connected, the joint portion 431 may be clamped into the first opening 602. Of course, in other embodiments not shown, the sidewall 6012 of the positioning slot 601 may not be provided with any opening, in which case the joint portion 431 of the locking member 420 may abut against the inner surface of the sidewall 6012, thereby also realizing the locking of the PSAS plug connector 500 and the PSAS receptacle connector 200 along the directions of plugging and unplugging.

Exemplarily, the elastic beam 430 may further comprise a tail portion 432 and a head portion 433. The tail portion 432 and the head portion 433 are disposed on both ends of the elastic beam 430, respectively. The tail portion 432 is fixed. The tail portion 432 may be fixed at any suitable position. In embodiments where the locking member 420 and the receptacle board lock 440 are of an integrated member, the tail portion 432 may be connected to the receptacle board lock 440 and thus fixed to the first circuit board 910 by the receptacle board lock 440. The joint portion 431 may be disposed between the head portion 433 and the tail portion 432. The receptacle insulating housing 300 has a second slot 302. The head 433 may be limited inside the second slot 302. And, when the PSAS receptacle connector 200 establishes a connection with or is disconnected from the mating PSAS plug connector 500, the head portion 433 may be configured to be movable inside the second slot 302 under the action of the joint portion 431.

In the process of establishing the connection between the PSAS receptacle connector 200 and the PSAS plug connector 500, the sidewall 6012 of the positioning slot 601 may squeeze the joint portion 431. In this way, the elastic beam 430 may be deflected with the tail portion 432 as a base, and the head portion 433 may move toward the insulating body 310 within the second slot 302. After the PSAS receptacle connector 200 is connected to the PSAS plug connector 500 in place, the elastic beam 430 may release an elastic potential energy. Within the second slot 302, the head portion 433 moves to an initial position in a direction away from the insulating body 310. With this configuration, the elastic beam 430 can have a better elasticity, so that it can facilitate the connection of the PSAS receptacle connector 200 to the PSAS plug connector 500.

Exemplarily, as shown in FIG. 3, the elastic beam 430 may further comprise a guide portion 434. The guide portion 434 may be disposed between the head portion 433 and the joint portion 431. The guide portion 434 may be inclined in a direction away from the head portion 433 toward the outer side of the receptacle insulating housing 300. The guide portion 434 and the joint portion 431 generally may be substantially V-shaped. A surface of the joint portion 431 back to the guide portion 434 may be a joint surface 431a for joining with the positioning slot 601. In the process of establishing the connection between the PSAS receptacle connector 200 and the PSAS plug connector 500, the guide portion 434 may squeeze against the wall of the positioning slot 601 prior to the joint portion 431. In this way, the guide portion 434 can provide a better guiding effect so that the elastic beam 430 is inserted into the positioning slot 601 more smoothly. Moreover, a chamfer is provided at a notch 6014 of the positioning slot 601, and the guide portion 434 and the chamfer may be inclined in a consistent trend. Under the action of the chamfer, the elastic beam 430 can enter into the positioning slot 601 more smoothly.

Exemplarily, the elastic beam 430 may further comprise a support portion 435. The support portion 435 may be disposed between the tail portion 432 and the joint portion 431. By disposing the support portion 435, the distance between the tail portion 432 and the joint portion 431 can be increased, resulting in a better elasticity at the joint portion 431 to facilitate the connection of the PSAS receptacle connector 200 with the PSAS plug connector 500.

Exemplarily, the support portion 435 may be straight as shown in FIGS. 11E-11H. With this configuration, the structure of the elastic beam 430 is simple and inexpensive to manufacture. As shown in FIGS. 11A-11D, the support portion 435 may be bent toward the inside of the receptacle insulating housing 300. With this configuration, the elasticity at the joint portion 431 is better and a sufficiently large joint surface 431a can be formed, so that the positioning slot 601 can be clamped to the first opening 602 of the positioning slot 601 anywhere on the joint surface 431a, which can improve tolerance to machining tolerances. Exemplarily, as shown in FIGS. 1-3 and 8-9, a first slot 303 recessed along the longitudinal direction X-X toward the insulating body 310 may be provided on the end face of the receptacle insulating housing 300. The bent support portion 435 of the elastic beam 430 may be accommodated within the first slot 303. Only the joint portion 431 may protrude beyond the first slot 303 to minimize the interference by the elastic beam 430 to the connection of the PSAS receptacle connector 200 with the PSAS plug connector 500.

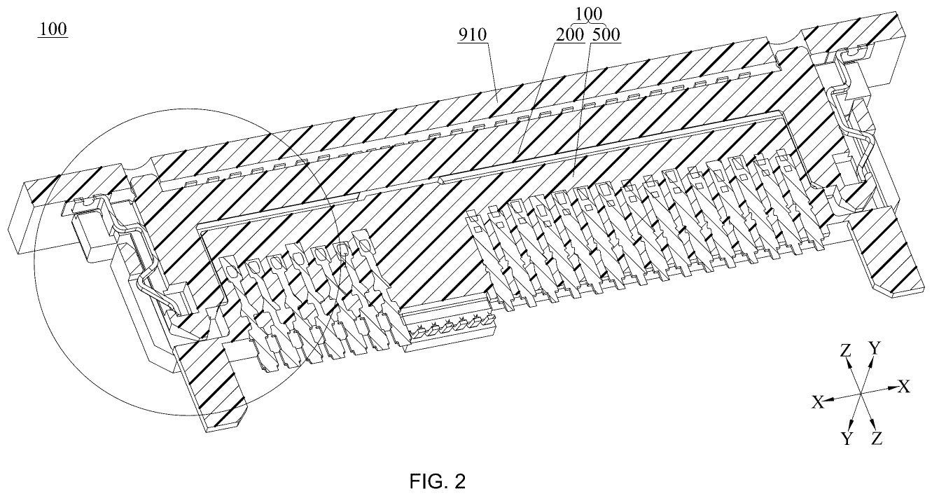

Exemplarily, as shown in FIGS. 2-3 and 8-9, along a reverse direction opposite to the protruding direction of the joint portion 431 (as indicated by the hollow arrows in FIGS. 3 and 9), the support portion 435 may abut against the receptacle insulating housing 300. Exemplarily, the support portion 435 may abut against the receptacle insulating housing 300 along the longitudinal direction X-X. The support portion 435 may abut against the wall of the first slot 303 of the guide 320. In the process of establishing the connection between the PSAS receptacle connector 200 and the PSAS plug connector 500, the receptacle insulating housing 300 (e.g., the wall of the first slot 303) may squeeze the support portion 435. After the PSAS receptacle connector 200 is connected to the PSAS plug connector 500 in place, the receptacle insulating housing 300 may exert a push force upon the elastic beam 430 toward the protruding direction of the joint portion 431, so that the head portion 433 moves more stably to the initial position to make the locking of the elastic beam 430 to the positioning slot 601 more secure and the connection of the PSAS receptacle connector 200 to the PSAS plug connector 500 more reliable.

Exemplarily, as shown in FIGS. 3 and 9, in a rest state, the side of the support portion 435 and that of the head portion 433 facing the above-described reverse direction may be disposed on the same plane perpendicular to the longitudinal direction X-X (i.e., the plane formed by the transverse direction Y-Y and the vertical direction Z-Z). In the illustrated embodiments, the side of the support portion 435 and that of the head portion 433 facing the above-described reverse direction is respectively the side facing the insulating body 310 at their right side. In the embodiments where the locking member 420 and the receptacle board lock 440 are of an integrated member, the receptacle board lock 440 is mounted to the receptacle insulating housing 300 from the receptacle mounting face 312 toward the receptacle mating face 311, and accordingly the elastic beam 430 is inserted into the first slot 303 of the guide 320 along this direction. The support portion 435 may slide all the way along the wall of the first slot 303 in the mounting process. It is desired that the head portion 433 may also slide along the wall of the first slot 303 in the mounting process. If the head portion 433 still protrudes toward the above-described reverse direction relative to the support portion 435, it will result in a more difficult mounting process. Conversely, if the head portion 433 does not reach the surface on which the support portion 435 is located, along the above-described reverse direction, it will result in the head portion 433 being closer to the outside of the receptacle insulating housing 300 than the support portion 435. As a result, the structure will not be compact enough and may lead to a waste of the already narrow space on the guide 320.

Exemplarily, as shown in FIGS. 1-3 and 8-9, the above-mentioned second slot 302 for limiting the head portion 433 may be recessed from the end face of the receptacle insulating housing 300 toward the insulating body 310. The second slot 302 and the first slot 303 may be disposed sequentially in a direction away from the receptacle mating face 311. The second slot 302 and the first slot 303 may be connected. The slot edge of the first slot 303 proximate to the receptacle mating face 311 may be provided with a blocking edge 302a extending toward the inside of the first slot 303. The head portion 433 is constrained by the blocking edge 302a and retained within the second slot 302. When the head portion 433 is at the initial position, the head portion 433 may abut against the blocking edge 302a. In this way, the blocking edge 302a may act as a limit.

Exemplarily, along the longitudinal direction X-X, the spacing between the blocking edge 302a and the bottom of the first slot 303 is equivalent to the thickness of the head portion 433. With this configuration, in the process that the elastic beam 430, along with the receptacle board lock 440, is mounted to the receptacle insulating housing 300 from the receptacle mounting face 312 toward the receptacle mating face 311, the head portion 433 can be inserted directly into the second slot 302 as it travels forward and abut against the blocking edge 302a. In other embodiments, along the longitudinal direction X-X, the spacing between the blocking edge 302a and the bottom of the first slot 303 may also be less or greater than the thickness of the head portion 433.

Exemplarily, along the longitudinal direction X-X, the dimension of the first slot 303 may be smaller than that of the second slot 302. As shown in FIG. 9, both the first slot 303 and the second slot 302 are recessed from the end face 322 of the guide 320 along the longitudinal direction X-X, and second slot 302 is recessed to a greater depth than the first slot 303. Increasing the longitudinal dimension of the second slot 302 may provide more room for movement of the head portion 433. In other embodiments, along the longitudinal direction X-X, the dimension of the first slot 303 may be equivalent to or greater than that of the second slot 302.

Exemplarily, along the transverse direction Y-Y, the dimension of the first slot 303 may be smaller than that of the second slot 302. The second slot 302 may even run through the receptacle insulating housing 300 along the transverse direction Y-Y. The transverse dimension of the first slot 303 may not be too large in order to ensure a limiting effect upon the support portion 435 so that the elastic beam 430 moves toward a desired direction. Increasing the transverse dimension of the second slot 302 facilitates the insertion of the head portion 433, thereby making the mounting of the elastic beam 430 easier. In other embodiments, along the transverse direction Y-Y, the dimension of the first slot 303 may also be equivalent to or greater than that of the second slot 302.

Exemplarily, as shown in FIGS. 1-3, the plug insulating housing 600 may further comprise a slot 620. The slot 620 may be disposed on the outer side of a longitudinal end of the insulating tongue 610. The positioning slot 601 may be used for receiving the guide 320 of the PSAS receptacle connector 200. A portion of the slot 620 may be formed as the positioning slot 601. The positioning slot 601 may be a standard one. That is, the positioning slot 601 may be of an existing structure and does not need to be redesigned and manufactured, so that existing design drawings and production processes can be used, thereby reducing workload and lowering manufacturing costs.

As previously described, the first opening 602 may be provided on a sidewall of the positioning slot 601 away from the insulating tongue 610. An edge 603 of the first opening 602 close to the plug mating face 611 may be configured to clamp the joint portion of the locking member 420. Exemplarily, the edge 603 may be in circular arc or slope shape. With this configuration, there is less friction between the edge 603 and the joint portion of the locking member 420, thereby allowing the PSAS receptacle connector 200 to be connected smoothly to the PSAS plug connector 500. Moreover, the wear rate of the edge 603 and the joint portion of the locking member 420 can be reduced to improve the service life of both.

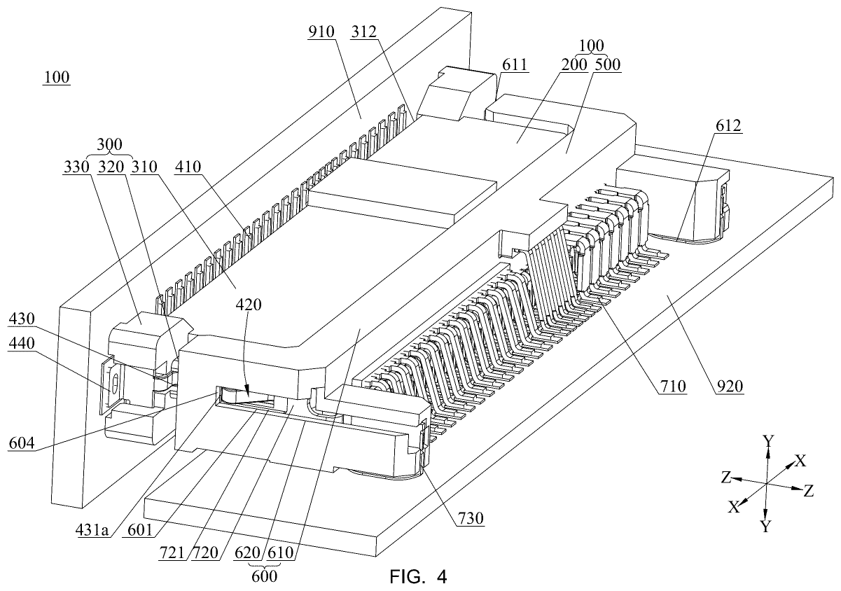

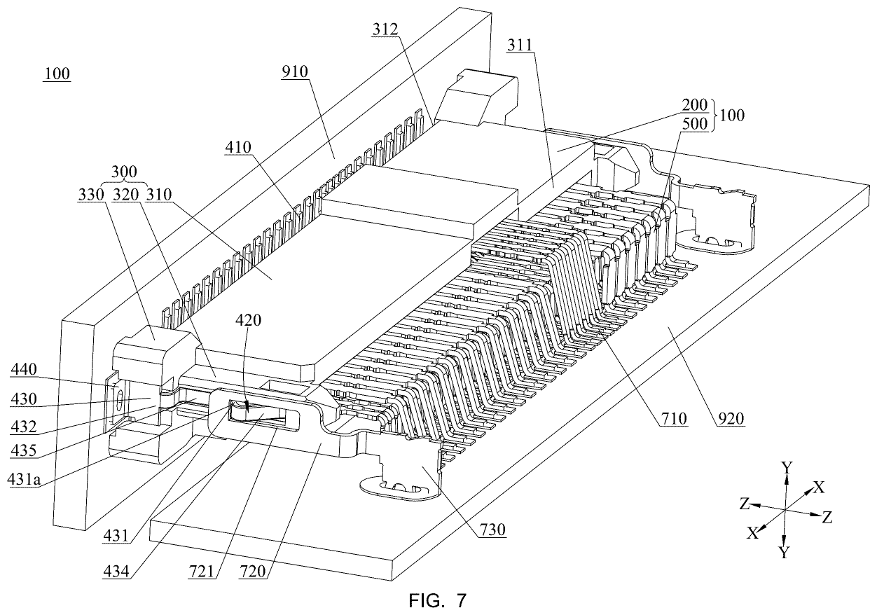

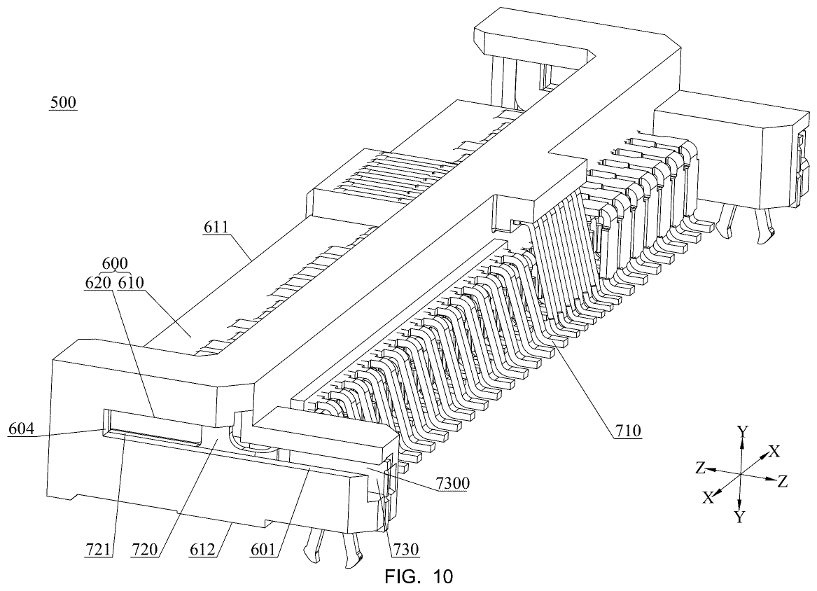

In another embodiment, as shown in FIGS. 4-7 and 10, a strengthening member 720 may be provided inside the positioning slot 601. A second opening 721 may be provided on the strengthening member 720. The second opening 721 may be configured to clamp the joint portion 431 of the locking member 420. In order to increase the clamping strength of the strengthening member 720 to the joint portion of the locking member 420 so as to increase the strength of the connection between the PSAS receptacle connector and the PSAS plug connector, the strengthening member 720 may be made of materials with stronger strength, such as plastics, ceramic, metal, etc. Preferably, the strengthening member 720 is a metal member. Metallic materials are stronger and have lower material and processing costs. With this configuration, the strengthening member 720 has a higher mechanical strength, is easier to process, and has lower material costs.

Exemplarily, a third opening 604 may be provided on a side wall of the positioning slot 601 away from the insulating tongue 610. The third opening 604 may expose the second opening 721. The joint portion 431 clamping the locking member 420 may extend through the second opening 721 into the third opening 604, such that the joint portion 431 has a sufficient protruding space. The third opening 604 may have the same structure as the first opening 602 in the embodiment shown in FIGS. 1-3. That is, the strengthening member 720 may also be disposed on the plug insulating housing 600 having the first opening 602. By providing the third opening 604, it may be convenient for the joint portion of the locking member 420 to protrude, thereby reducing the dimension of the PSAS plug connector 500 for miniaturization. In the case that there is the strengthening member 720, it is possible not to provide any opening, just relying on the strengthening member 720 to clamp the joint portion 431 of the locking member 420.

Exemplarily, the PSAS plug connector 500 may further comprise a plug board lock 730. The plug board lock 730 may be connected to the plug insulating housing 600. The plug board lock 730 may be configured to fix the plug insulating housing 600 to the second circuit board 920. The plug board lock 730 may be made of materials with stronger strength such as plastics, ceramic, metal and so on. Preferably, the plug board lock 730 is made of metallic materials. Metallic materials have stronger strength and lower material and processing costs. The plug board lock 730 is manufactured separately from the plug insulating housing 600. One end of the plug board lock 730 may be fixed to the plug insulating housing 600 by interference fit, and the other end may be fixed to the second circuit board 920 by any suitable methods such as clamping pieces, welding, or connection pieces.

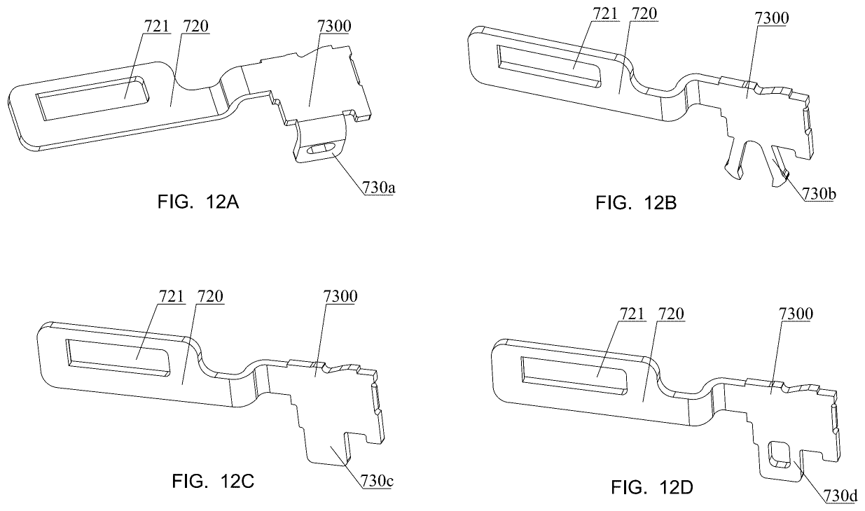

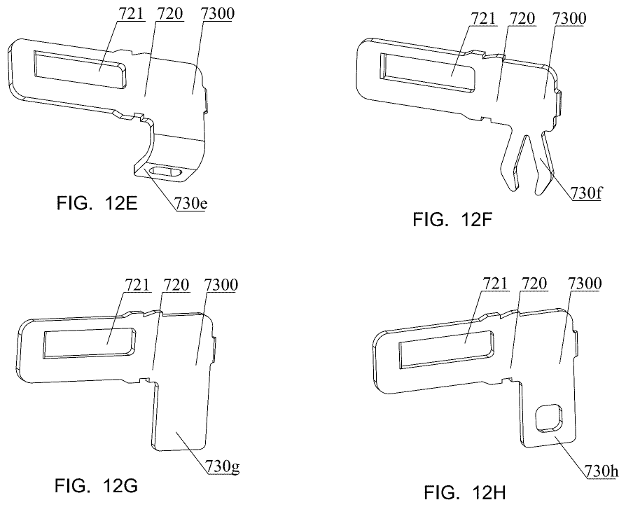

In conjunction with FIGS. 12A-12H for reference, the plug board lock may have a variety of forms. As illustrated, a plug board lock 730b and a plug board lock 730f may respectively include a fork lock. The fork lock has ends spaced apart so that it can be elastic. The plug board lock 730b and the plug board lock 730f may be fixed to the second circuit board 920 by inserting and clamping the fork lock into the through-hole on the second circuit board 920. A plug board lock 730c and a plug board lock 730g may respectively include a tab. The plug board lock 730c and the plug board lock 730g may be fixed to the second circuit board 920 by inserting and clamping the tab into the through-hole on the second circuit board 920. A plug board lock 730d and a plug board lock 730h may respectively include a SMT soldering tail perpendicular to the second circuit board 920. The plug board lock 730d and the plug board lock 730h may be fixed to the second circuit board 920 by inserting the SMT soldering tail into the through-hole on the second circuit board 920 and soldering it onto the second circuit board 920. A plug board lock 730a and a plug board lock 730e may respectively include a SMT soldering tail parallel to the second circuit board 920. This SMT soldering tail differs from the perpendicular SMT soldering tail as shown in FIGS. 12D and 12H in different orientation. With respect to the plug board lock 730a and the plug board lock 730e, they may abut against the second circuit board 920, and the second circuit board 920 may not be provided with a corresponding through-hole.

Regardless of the manners by which the plug board locks are locked to the second circuit board 920, the plug board locks 730a, 730b, 730c, 730d, 730e, 730f, 730g, 730h are substantially in slice shape. They may all be connected to the plug insulating housing 600 by the interference fit. For example, plug board lock bodies 7300 of the plug board locks 730a, 730b, 730c, 730d, 730e, 730f, 730g, 730h that are connected to the plug insulating housing 600, referring to FIGS. 12A-12H, are retained on the plug insulating housing 600. The plug board lock body 7300 may be configured to be mounted to the plug insulating housing 600 along a direction from a plug mounting face 612 toward a plug mating face 611. And the plug board lock 730 may be in interference fit with the plug insulating housing 600. In this way, after the PSAS receptacle connector 200 is connected to the second circuit board 920, the PSAS plug connector 500 together with the second circuit board 920 can limit the strengthening member 420 and the plug board lock 730.

Exemplarily, as shown in FIGS. 12E-12H, the strengthening member 720 may be disposed on the same plane as the plug board lock body 7300. With this configuration, the strengthening member 720 and the plug board lock body 7300 have a simple structure and are inexpensive to manufacture. As shown in FIGS. 12A-12D, the portion of the strengthening member 720, in which the second opening 721 is located, is offset relative to the plug board lock body 7300 toward the outside of the plug insulating housing 600. The offset structure may form a step, which can provide a positioning effect.

Exemplarily, the strengthening member 720 and the plug board lock 730 may be separate, with each being a separate component. Exemplarily, the strengthening member 720 and the plug board lock 730 may be joined together by any suitable methods such as welding, bonding, molding and so on. Preferably, the strengthening member 720 and the plug board lock 730 may be an integrated member formed by punching and so on. In a typical PSAS plug connector 500, the plug board lock 730 is made of metallic materials. Forming the strengthening member 720 integrally with the plug board lock 730 can reduce processing costs. Moreover, the strengthening member 720 may follow the plug board lock 730 to be made of metallic materials as well. The strengthening member 720 made of metallic materials may have better mechanical strength.

Exemplarily, the third opening 604 may extend through to the plug mounting face 612. With this configuration, the strengthening member 720 may be mounted from the plug mounting face 612 into the positioning slot 601.

The present disclosure has been described through the above embodiments, but it should be understood that a variety of variations, modifications and improvements may be made by a person skilled in the art according to the teaching of the present disclosure, and these variations, modifications and improvements all fall within the spirit of the present disclosure and the claimed scope of protection of the present disclosure.

As one example, a receptacle is described as mounted to a PCB and a plug is described as mounted to a PCB or a cable. The mating interfaces may be interchanged, and the plug may be mounted to a PCB and the receptacle may be mounted to a cable. Similarly, a vertical plug connector and a right angle receptacle are used to illustrate techniques that may be used in mating connectors, but either or both of the plug and receptacle may have a vertical or right angle orientation, as another example.

Accordingly, the scope of protection of the present disclosure is defined by the appended claims and its equivalent scope. The above embodiments are only for the purpose of illustration and description, and are not intended to limit the present disclosure to the scope of the described embodiments.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like usually are shown based on the accompanying drawings, only for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

Moreover, although many creative aspects have been described above with reference to the vertical connectors, it should be understood that the aspects of the present disclosure are not limited to these. Any one of the creative features, whether alone or combined with one or more other creative features, can also be used for other types of card edge connectors, such as coplanar connectors, and the like.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising a body having a mating face and a mounting face, a slot extending along the body, and a guide disposed at an end of the body and having a first slot;
a plurality of conductive elements held by the housing, each of the plurality of conductive elements extending from the mounting face into the slot; and
a locking member comprising a beam fixedly disposed in and curving out of the first slot of the guide.

2. The electrical connector of claim 1, wherein the beam comprises
a tail portion fixedly disposed in the first slot of the guide,
a head portion opposite the tail portion and disposed in a second slot of the guide such that the head portion is movable inside the second slot of the guide, and
a joint portion disposed between the head portion and the tail portion and protruding out of the guide.

3. The electrical connector of claim 2, wherein the beam further comprises
a guide portion joining the head portion and the joint portion, the guide portion inclined in a direction away from the head portion and out of the guide.

4. The electrical connector of claim 2, wherein the elastic beam further comprises
a support portion joining the tail portion and the joint portion and extending straight or bent toward the body of the housing.

5. The electrical connector of claim 4, wherein:
in a rest state, a side of the support portion that abuts the wall of the first slot and a side of the head portion abutting a blocking edge are aligned in a same plane.

6. The electrical connector of claim 2, wherein:
the second slot and the first slot are disposed sequentially along a direction away from the mating face and connected to each other.

7. The electrical connector of claim 1, comprising:
a board lock held by the housing, wherein the locking member and the board lock are integrated or separate.

8. The electrical connector of claim 7, wherein:
the housing further comprises a board mounting seat adjacent to the mounting face; and
the board lock is mounted to the board mounting seat.

9. The electrical connector of claim 1, wherein:
the locking member is a metal member.

10. An electrical connector comprising:
a housing comprising a tongue having a mating face, and a guide disposed at an end of the tongue and having a slot configured to receive a guide of a mating connector, the slot comprising a portion configured to receive a locking member of the mating connector; and
a plurality of conductive elements held by the tongue, each of the plurality of the conductive elements comprising a portion disposed on a surface of the tongue, the portion disposed on the surface of the tongue having a length shorter than a standard length according to a PSAS standard.

11. The electrical connector of claim 10, wherein:
the portion of the receiving slot comprises a first opening disposed on a sidewall of the guide and away from the tongue; and
an edge of the first opening is proximate to the mating face and configured to clamp a joint portion of the locking member of the mating connector.

12. The electrical connector of claim 11, wherein:
the sidewall of the guide comprises a chamfer configured to engage the locking member of the mating connector.

13. The electrical connector of claim 11, comprising:
a strengthening member disposed in the portion of the receiving slot, the strengthening member comprising a second opening configured to clamp the locking member of the mating connector.

14. The electrical connector of claim 13, comprising:
a third opening disposed on the sidewall of the guide and exposing the second opening,
wherein the second opening of the strengthening member is disposed between the first opening and the third opening that are disposed on the sidewall of the guide.

15. The electrical connector of claim 14, wherein:
the third opening extends through an end of the guide.

16. The electrical connector of claim 13, further comprising:
a board lock held by the housing, wherein the strengthening member and the board lock are integrated or separate.

17. The electrical connector of claim 16, wherein:
the board lock has a body connected with the housing and extending from a mounting face toward the mating face.

18. The electrical connector of claim 17, wherein:
the strengthening member is disposed on a same plane as the body of the board lock, or
a portion of the strengthening member in which the second opening is located is offset relative to the body of the board lock body in a direction away from the tongue of the housing.

19. An interconnection system comprising:
a first electrical connector comprising:
a housing comprising a body, a slot extending along the body, and a guide disposed at an end of the body and having a first slot;
a plurality of conductive elements held by the housing, each of the plurality of conductive elements extending into the slot; and
a locking member disposed in and curving out of the first slot of the guide; and a second electrical connector mated with the first electrical connector, the second electrical connector comprising:
a housing comprising a tongue inserted in the slot of the first electrical connector, and a guide disposed at an end of the tongue and having a slot, wherein:
the guide of the first connector is inserted in the slot of the guide of the second electrical connector;
the slot of the guide of the second electrical connector comprises a portion that has an opening disposed on a sidewall of the guide; and
the locking member of the first electrical connector is inserted in the portion of the slot and curves into the opening.

20. The interconnection system of claim 19, wherein:
the second electrical connector comprises a plurality of conductive elements held by the tongue and mated with the plurality of conductive elements of the first electrical connector; and
the conductive elements of the first connector and the conductive elements of the second connector are configured such that, when the locking member is engaged in the opening, a stub length of mated conductive elements is less than 1.7 mm or shorter than a stub length specified in a PSAS standard.
